(19) United States
(12) Patent Application Publication
(10) Pub. No.: US 2007/0277061 A1
(43) Pub. Date: Nov. 29, 2007

(54) System, Method, Computer Program Product And Article Of Manufacture For Remote Fault Diagnosis And Correction In A Computer System

(76) Inventor: George Michael Ashe, Salisbury (GB)

Correspondence Address: GORDON & JACOBSON, P.C., 60 LONG RIDGE ROAD, SUITE 407, STAMFORD, CT, 06902, US

(21) Appl. No.: 11/683,094

(22) Filed: Mar. 7, 2007

(30) Foreign Application Priority Data
Mar. 7, 2006 (GB) 0604492.9

(51) Int. Cl. G06F 11/07

(52) U.S. Cl. 714/57; 714/48

(57) ABSTRACT

A method for fault diagnosis in a computer system comprises producing a log file of a user's interaction with a Graphical User Interface (GUI) of a user computer, omitting from the log file any text entered by the user during the interaction, and diagnosing the fault by reviewing the log file. The log file may be transmitted over a computer network for reviewing at a remote computer. The log file of GUI activity is small and does not occupy much storage space on a computer. The recordal of the user's interaction with the computer's Graphical User Interface (GUI) is a relatively straightforward process which utilises a minimal amount of the computer's processor and memory resources. The log which describes the user's interaction with the operating system's user interface and each application's user interface, captures the exact context of each interaction and enables a rapid fault diagnosis to be made by a technician.

### BACKGROUND OF THE INVENTION

1. Field of the Invention

This invention relates to a method, a computer program product and an article of manufacture to help technicians, engineers and the like to diagnose faults in a user's computer.

2. Related Background Art

Over recent years the complexity of computers and computer software has increased considerably, with the result that users often experience hardware and software faults and conflicts, which can cause their computer to operate incorrectly or crash.

Organisations can suffer substantial losses of productivity due technical problems on computers and, since most users do not have the necessary skill level to diagnose or correct faults themselves, problems have to be solved by calling a technician or engineer. However, the provision of technical support for users is a major expense within most organisations, particularly if site visits are required. Current technical support arrangements are a major source of dissatisfaction to users and there is often friction between users and technical support departments.

In order to alleviate the costs of site visits, tools for remotely diagnosing and correcting computer system faults have been developed. However, whilst such technical support tools are effective, they do suffer from a number of limitations.

Firstly, problems on remote computers can often be very difficult to diagnose without detailed information from the potentially unskilled user. Accordingly, the technicians and engineers behind remote support workstations require tact, patience and diplomacy as well as technical skill. In most cases, the technicians and engineers need to establish the context within which the problem occurred and, in particular, establish what the user was doing prior to the occurrence of the problem. Unfortunately, most users are often unable to recall and communicate this information with sufficient precision for the technician or engineer to determine the nature of the fault. Also, the process can be extremely time consuming for both parties.

Secondly, some known technical support tools comprise software which records an application program's execution in logs, which can then be examined by the technicians or engineers to determine the fault. Such tools are limited however because they require code within an application to perform the recording, which makes them application specific.

Other known technical support tools utilise logging mechanisms that are provided in some operating systems which are capable of recording the status of hardware and software subsystems. Such tools are limited in scope and show little trace of a user's actions.

Another kind of support tool uses software which tracks key strokes and mouse movements and can also provide a record of a user's actions for diagnostic purposes. However, the way in such tools collect and log data can endanger and compromise the privacy and security of individuals and organisations, for example by recording passwords.

### SUMMARY OF THE INVENTION

I have now devised a method and architecture to help technicians, engineers and the like to diagnose faults in a computer system.

In accordance with this invention there is provided a method for fault diagnosis in a computer system; the method comprising the steps of:
a) producing a log of a user's interaction with a Graphical User Interface (GUI) of a user computer;
b) omitting from said log any text entered by said user during said interaction;
c) storing said log in a log file; and diagnosing said fault by reviewing said log file.

The user's interaction with the computer's Graphical User Interface (GUI) is recorded in a file, which is surprisingly small and does not occupy much storage space on a computer. The recordal of the user's interaction with the computer's Graphical User Interface (GUI) is a relatively straightforward process which utilises a minimal amount of the computer's processor and memory resources. The log which describes the user's interaction with the operating system's user interface and each application's user interface, captures the exact context of each interaction and enables a rapid diagnosis to be made by a technician.

Any sensitive data, such as passwords or other text, entered by the user can be omitted from the log file. The size of the log file enables it to be quickly transmitted to a support computer without utilising much of the network's resources.

In a first embodiment, a technician may make a local diagnosis of the fault directly on a user's computer.

In a second embodiment, a technician may make a remote diagnosis of the fault over a computer network on a support computer. In this embodiment, the method preferably comprises transmitting said log file to said support computer over said computer network in the event of a fault.

In either embodiment, the method preferably further comprises producing, from said log file, a solution to the fault in the form of at least one action to be performed on said user computer and performing, on said user computer, the action(s) to implement a solution to said fault.

In the second embodiment, a file containing said action(s) is preferably transmitted to said user computer over said network.

Preferably the text entered by the user is omitted from the log file by deleting it or by changing any alpha-numeric characters to null or different characters, thereby rendering the text unreadable.

Preferably, data in the log is securely deleted after a user-specified period.

Preferably said storing step further comprises storing, preferably in said log file, one or more screen shots captured by the user upon occurrence of the fault.

Preferably selected areas of the screen are deleted from the screen shots prior to storage, thereby enabling any sensitive data on the screen to be omitted.

Preferably said storing step further comprises recording and storing, preferably in said log file, details of hardware and/or software on said user computer.

In the second embodiment, a request file is preferably compiled at said support computer in response to said log file, said request file comprising one or more requests for information about hardware and/or software on said user computer, the request file then being transmitted over the network to said user computer.

Preferably, a question to the user is also added to said request file.

Preferably the request(s) are displayed to the user at said user computer, the user being able to approve or disapprove any request, in order to preserve the sensitive information.

Preferably, a response file is compiled at said user computer in response to said request file, said response file comprising requested information about hardware and/or software on said user computer, the response file then being transmitted over the network to said support computer.

Preferably said solution to the fault, in the form of said at least one action to be performed on said user computer, is produced in response to information contained in said log and/or said response files from the user computer.

Preferably said solution comprises transmitting a solution file to the user computer over the network, the solution file comprising a script which is executable on the user computer to perform each action.

Preferably the actions(s) are displayed to the user at said user computer, the user being able to approve or disapprove any action prior to performing the action on the user computer.

By the term “file” in the foregoing, it will be appreciated that data can be transmitted between the user and support computers as single or multiple files, which may be encrypted and/or compressed.

Also in accordance with this invention, there is provided a computer program product, comprising program code portions for performing steps of the method as hereinbefore described on one or more computers.

Preferably the product comprises a first portion for performing steps on a user computer and a second portion for performing steps on a support computer.

Also in accordance with this invention, there is provided an article of manufacture with a computer usable medium having computer readable instructions embodied therein for providing access to resources available on that computer, the computer readable instructions comprising instructions to cause the computer to perform the steps of the method as hereinbefore described.

Also in accordance with this invention, there is provided a computer network comprising at least one user computer and at least one support computer, each computer being configured to implement the relevant steps of the method as hereinbefore described.

### BRIEF DESCRIPTION OF THE DRAWINGS

An embodiment of the present invention will now be described by way of an example only and with reference to the accompanying drawings, in which:

FIG. 1 is a block diagram of a computer system in accordance with the present invention;

FIG. 2 is a diagram illustrating how a user's interaction with a computer of the system of the system of FIG. 1 is recorded;

FIG. 3 is a block diagram illustrating the initial steps of a method in accordance with the present invention for remotely diagnosing faults on the computer system of FIG. 1;

FIG. 4 is a block diagram illustrating subsequent steps of the method of FIG. 3; and

FIG. 5 is a block diagram illustrating the final steps of the method of FIG. 3.

### DETAILED DESCRIPTION OF THE PREFERRED EMBODIMENT

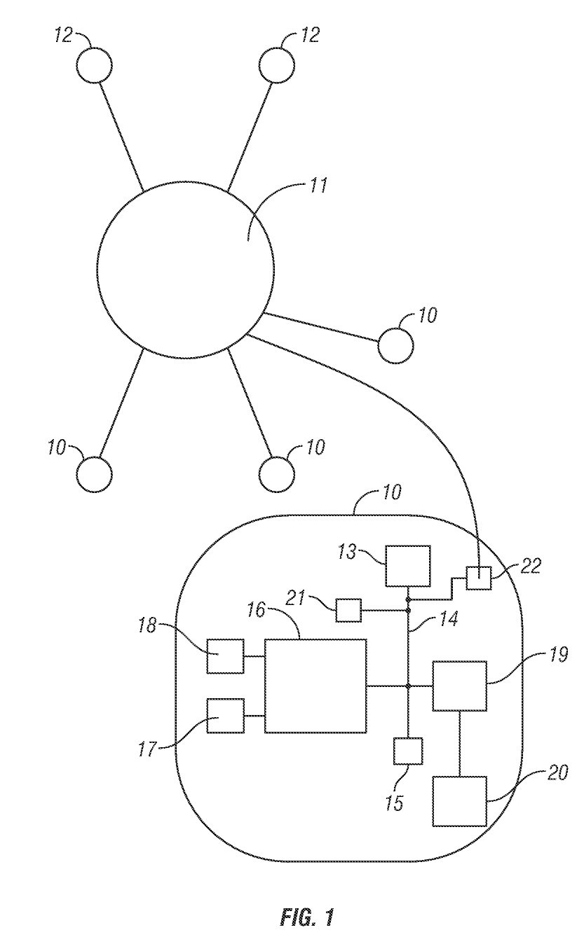

Referring to FIG. 1 of the drawings, there is shown a plurality of business user computers 10 connected to a network 11, such as a local area network (LAN), a virtual private network (VPN), the Internet or another wide area network (WAN). A plurality of support computers 12 are also connected to the network 11.

As depicted, each user computer 10 includes a microprocessor 13 and a bus 14, which enables communication between the microprocessor 13 and other components of the computer 10 in accordance with well known techniques. The computer 10 will typically include a user interface adapter 16 for connecting the microprocessor 13 via the bus 14 to one or more of interface devices, such as a keyboard 17 and a mouse 18 or other selection cursor device. The bus 14 also connects a display device 20, such as an LCD screen or monitor, to the microprocessor 13 via a display adapter 19. The bus 14 also connects the microprocessor 13 to a memory 15 and to a permanent storage device 21, such as a hard drive, tape, disk, etc. The computer 10 communicates via a communications adapter 22 to the network 11 and thence to the other user and support computers 10,12.

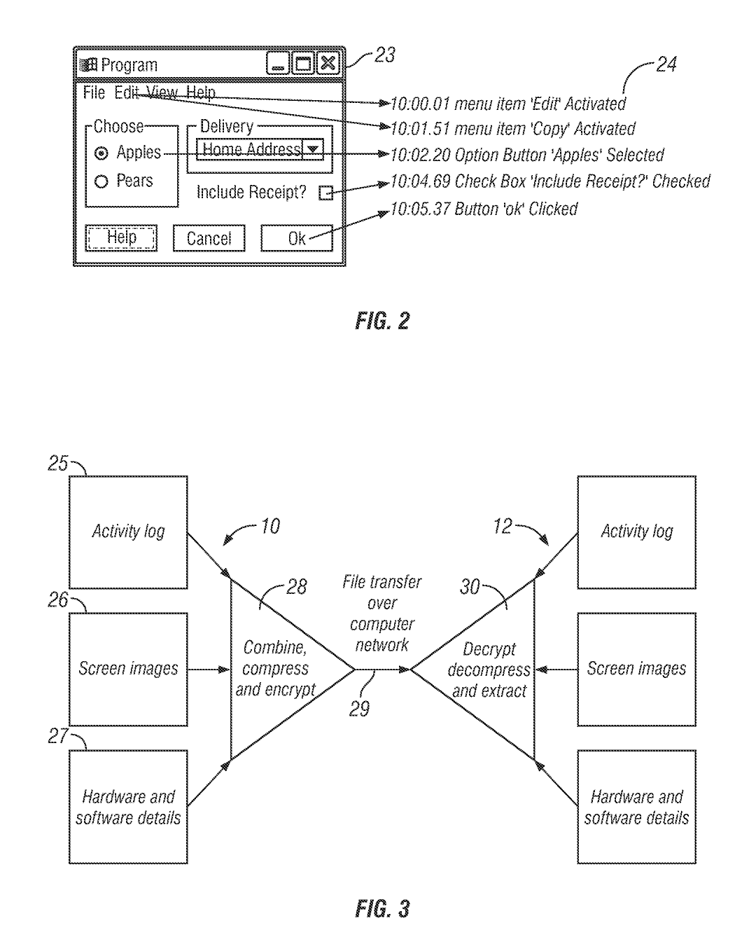

Referring to FIG. 2 of the drawings, in use each user runs the relevant business application software on their computer 10 and interfaces with the software by utilising the keyboard 17 and mouse 18 to entering commands in conjunction with a Graphical User Interface (GUI) e.g. 23, which displays icons, menu items, buttons, list boxes, words and other graphical elements on the screen of the display device 20.

In accordance with the present invention, each user computer 10 also runs support software which monitors the user's interaction with the Graphical User Interface (GUI) of their computer 10. This is achieved by tracking:
a) which GUI element has the current focus as well as the window and application which owns that GUI element; and
b) each keyboard key movement and each mouse (or alternative pointing device) button movement.

The software is thereby able to determine which GUI element captures a given keyboard key movement or mouse (or alternative pointing device) button movement and the window and application which owns that GUI element. These details are encrypted and stored in a file on the permanent storage device 21, together with a time stamp of the relevant action. The file essentially comprises a log 24, which lists the user's interaction with the operating system's user interface and the user interface of the relevant business application software, capturing the exact context of each interaction. Any alpha-numeric text which is typed by the user is merely stored in the log file as null or randomised characters, so that passwords and other sensitive or confidential information is omitted. The support software is arranged to securely delete the log file after a user-specified period.

Referring to FIG. 3 of the drawings, when a fault occurs and a user requires technical support, the user clicks a relevant support icon displayed by the support software on their display device 20, thereby causing the support software to retrieve a copy of the most recent activity log 24 from the permanent storage device 21 at step 25. Alternatively, the user computer may be arranged to initiate this step upon detection of a fault.

At step 26, the software also captures the current screen image. The user is given the option to add this image plus any other captured screen images that the user may consider to be of relevance to the fault file 27.

Finally, at step 27, the support software collects details of the current state and configuration of the computer 10. The user is then given the option to preview all of these details for security and privacy reasons, and in the case of the screen images, to cut or obliterate any part of any image which may contain confidential matter.

The three aforementioned sources of fault data from steps 25 to 27 are combined, compressed and encrypted into a single fault single file at step 28, which is then transmitted over the network 11 to a support computer 12 at step 29. In this manner, the information required by a technician to fully understand the events leading up to a fault is recorded whilst potentially sensitive or confidential information, such as text typed into dialog boxes or areas of the screen are not. Optionally, the file can be attached to a record or so-called ticket in an automated help desk system.

When the file is received by the support computer 12 and opened, the file is decrypted and decompressed at step 30 to allow the activity log, screen images, and hardware and software details to be examined by the technician.

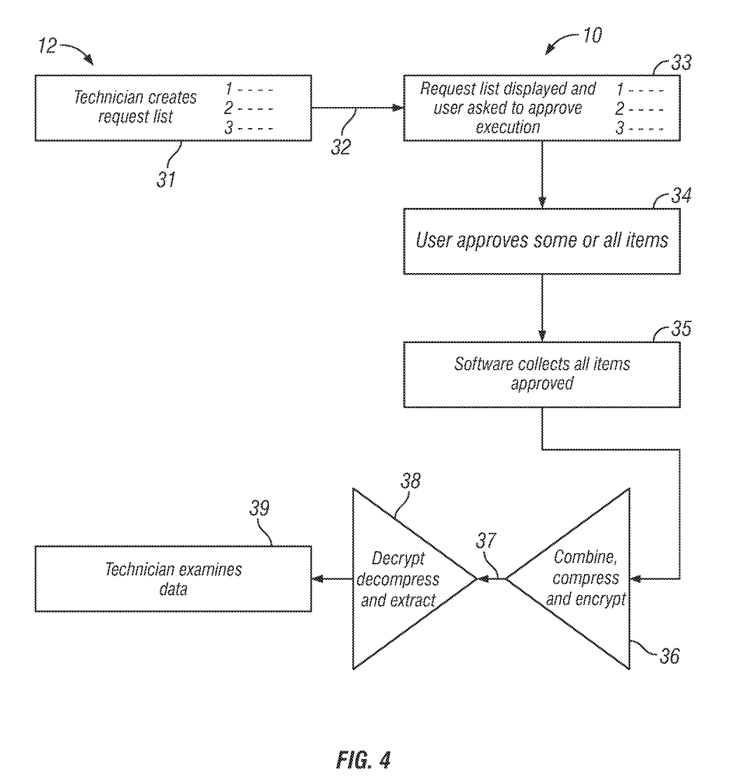

Referring to FIG. 4 of the drawings, should the technician need to obtain further information, the technician can create a request file at step 31, comprising a list of requests, for example for details of:
a) the application settings;
b) the system settings;
c) the nature or content of files;
d) the directory structure of drives;
e) file or directory permissions;
f) file flags; and/or
g) file date stamps and sizes.

The technician can also add a question to the user. The request file is sent over the computer network 11 to the user's computer 10 at step 32. The request list is displayed on the user's display device 20 at step 33 and the user is asked to approve the list of requests.

The user approves some or all of the items in the request list at step 34, whereupon the software collects all of the items which have been approved by the user at step 35. If the technician has added a question, the user is given the option to type a response. All the requested items are combined in a single response file, then compressed and encrypted at step 36. This response file is sent over the computer network 11 to the technician's support computer 12 at step 37. Optionally, the response file can be attached to a record or so-called ticket in an automated help desk system.

When the response file is received by the support computer 12 and opened, the file is decrypted and decompressed at step 38 to allow the individual items to be extracted and examined by the technician at step 39.

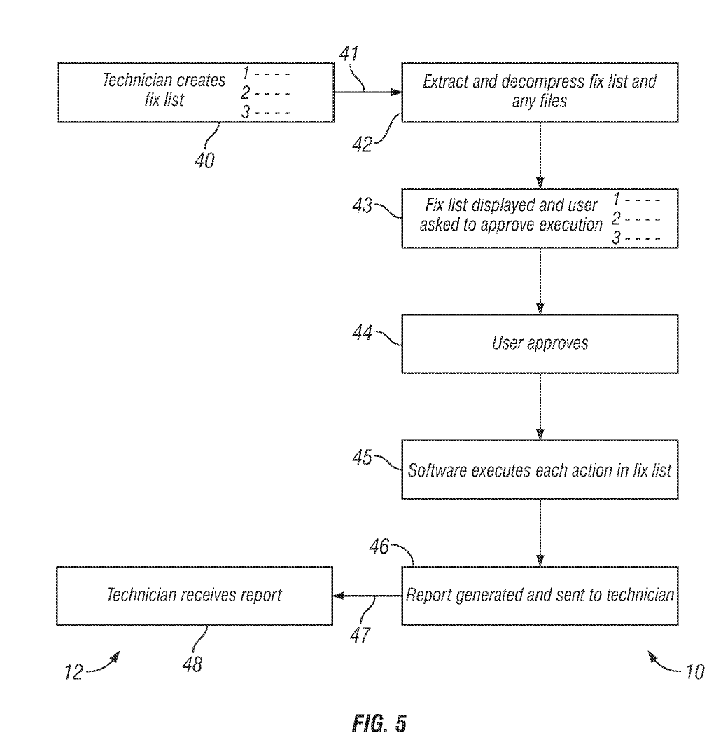

Referring to FIG. 5 of the drawings, once the technician has all of the required information, a solution file can be created at step 40. The solution file can contain:
a) a change to a system or application setting; and/or
b) the replacement, addition or deletion of a file or files.

The above may be achieved by adding one or more executable files/scripts and/or instructions for the user to perform to the solution file. Also, the solution file may contain an explanation by the technician of the reasons and implications of the changes.

The compressed and encrypted solution file is sent over the computer network 11 to the user's computer 10 at step 41. The file is decrypted and decompressed at step 42 to allow the list of solutions is displayed on the user's display device 20 at step 43. The list of solutions is displayed together with any message from the technician and the user asked to approve the execution of all the items on the list.

In the event that the user does not approve the execution of all the items on the list, the user is prompted to type a message to the technician to explain the rejection. This message is then sent to the technician over the computer network 11. No further processing takes place.

In the event that the user does approve the items in the fix list, the support software executes each action in the fix list at step 45, for example by. changing settings, replacing files etc. If an action on the list fails, the execution of the remaining actions is cancelled, and the preceding items in the list reversed or rolled back. The reversal is performed by recording the prior state before each change. When a reversal is needed, the prior states are restored in reverse order.

A report is generated showing either that each item was completed successfully, or which was the first item to fail and confirming the success of the reversal or roll back. This report is stored in a report file at step 46 and sent to the technician over the computer network 11 at step 47. The technician receives the report at step 48.

Whilst the recording of user activity would normally be viewed as a severe security risk and highly inappropriate for use in a technical support context, the present invention monitors the user's interaction with the Graphical User Interface (GUI) of their computer 10 and encrypts and stores this in a log file in such a manner that security is not compromised.

The logging process uses minimal resources on the user's computer, with less than 1% of the processor and memory resources being used. Furthermore, the size of the files sent across the network between the user and support computers 10, 12 during the various stages are so small that they are quickly transmitted and use little network resources. Typically, the files are less than 600K in size, even when including a screen shot at 1600×1200 pixels.

The log file makes it easy for the technician to examine the user's interaction with the operating system and software applications right up to the point of the problem. The technician is thus provided with all of the information necessary to fix most problems quickly, thereby leading to major productivity gains for both technicians and users.

The present invention is typically embodied as user side software programming code, which may be stored in the permanent storage 21 of each user computer 10. Also, support side software programming code is provided, which may be stored in the permanent storage of each support computer 12. In a client server environment, however, such user and/or support side software programming code could be stored in the storage associated with a server.

The software programming code in which the invention is embodied can itself be implemented on any of a variety of known media for use with a data processing system such as a floppy disk, tape, hard drive or CD ROM. The code may be distributed on such media or distributed to users from the memory or storage of one computer system over a communications network of any given type to other computer systems for use by users of such systems. The techniques and method of embodying software program code on physical media and/or for distributing or embodying the code via networks are well known and will not be further discussed herein.

The present invention has been particularly shown and described with respect to a certain embodiment and specific features thereof. However, it should be noted that the above-described embodiment is intended to describe the principles of the invention, not limit its scope. Therefore, as is readily apparent to those of ordinary skill in the art, various changes and modifications in form and detail may be made without departing from the spirit and scope of the invention as hereinbefore defined. Other embodiments and variations to the depicted embodiments will be apparent to those skilled in the art and may be made without departing from the spirit and scope of the invention as hereinbefore defined. Further, reference in the foregoing to an element in the singular is not intended to mean “one and only one” unless explicitly stated, but rather, “one or more”.

I claim:

1) A method for fault diagnosis in a computer system; the method comprising the steps of:
a) producing a log of a user's interaction with a Graphical User Interface (GUI) of a user computer;
b) omitting from said log any data text entered by said user during said interaction; and
c) storing said log in a log file for diagnosing said fault.

2) A method as claimed in claim 1, comprising making a local diagnosis of the fault directly on said user's computer.

3) A method as claimed in claim 1, comprising producing, from said log file, a solution to the fault in the form of at least one action to be performed on said user computer and performing, on said user computer, the action(s) to implement a solution to said fault.

4) A method as claimed in claim 1, comprising making a remote diagnosis of the fault over a computer network on a support computer.

5) A method as claimed in claim 4, comprising transmitting said log file to said support computer over said computer network in the event of a fault.

6) A method as claimed in claim 5, comprising producing, from said log file, a solution to the fault in the form of at least one action to be performed on said user computer and performing, on said user computer, the or each action to implement a solution to said fault.

7) A method as claimed in claim 5, comprising transmitting a file containing said action(s) from said support computer to said user computer over said network.

8) A method as claimed in claim 1, in which the text entered by the user is omitted from the log file by deletion.

9) A method as claimed in claim 1, in which the text entered by the user is omitted from the log file by changing any alpha-numeric characters to null or different characters to render the text unreadable.

10) A method as claimed in claim 1, in which data in said log is securely deleted after a user-specified period.

11) A method as claimed in claim 1, in which said storing step further comprises storing in said log file, one or more screen shots captured by the user upon occurrence of the fault.

12) A method as claimed in claim 11, in which said storing step comprises storing said one or more screen shots in said log file.

13) A method as claimed in claim 11, in which selected areas of the screen are deleted from said screen shots prior to storage to enable any sensitive data on the screen to be omitted.

14) A method as claimed in claim 1, in which said storing step further comprises recording and storing details of hardware and/or software associated with said user computer.

15) A method as claimed in claim 1, in which said details of said hardware and/or software associated with said user computer are stored in said log file.

16) A method as claimed in claim 4, in which a request file is compiled at said support computer in response to said log file, said request file comprising one or more requests for information about hardware and/or software on said user computer, the request file then being transmitted over the network to said user computer.

17) A method as claimed in claim 16, in which a question to the user is also added to said request file.

18) A method as claimed in claim 16, in which the request(s) are displayed to the user at said user computer, the user being able to approve or disapprove any request, in order to preserve sensitive information.

19) A method as claimed in claim 16, in which a response file is compiled at said user computer in response to said request file, said response file comprising requested information about hardware and/or software on said user computer, the response file then being transmitted over the network to said support computer.

20) A method as claimed in claim 19, in which said solution to the fault, in the form of said at least one action to be performed on said user computer, is produced in response to information contained in said log and said response files from the user computer.

21) A method as claimed in claim 20, in which said solution comprises transmitting a solution file to the user computer over the network, the solution file comprising a script which is executable on the user computer to perform each action.

22) A method as claimed in claim 1, in which said solution to the fault, in the form of said at least one action to be performed on said user computer, is produced in response to information contained in said log.

23) A method as claimed in claim 22, in which the or each actions is are displayed to the user at said user computer, the user being able to approve or disapprove any action prior to performing the action on the user computer.

24) A computer program product, comprising program code portions for performing the steps of the method as claimed in claim 1.

25) A computer program product as claimed in claim 25, comprising a first portion for performing said steps on said user computer and a second portion for performing steps on a support computer.

26) An article of manufacture with a computer usable medium having computer readable instructions embodied therein for providing access to resources available on that computer, the computer readable instructions comprising instructions to cause the computer to perform the steps of the method as claimed in claim 1.

27) A computer network comprising at least one user computer and at least one support computer, each computer being configured to implement the relevant steps of the method as claimed in claim 4.
